(19) United States
(12) Patent Application Publication
(10) Pub. No.: US 2002/0061266 A1
(43) Pub. Date: May 23, 2002

(54) Apparatus for manufacturing activated carbon fiber

(75) Inventors: Hidehiko Maki, Inugami-gun (JP); Masayuki Fujimori, Inugami-gun (JP); Kaneto Ohyama, Inugami-gun (JP); Akitaka Asano, Inugami-gun (JP)

Correspondence Address: MCDERMOTT, WILL & EMERY, 600 13th Street, N.W., Washington, DC, 20005-3096, US

(73) Assignee: DYNIC Corporation

(21) Appl. No.: 09/953,925

(22) Filed: Sep. 18, 2001

(30) Foreign Application Priority Data
Sep. 19, 2000 (JP) 2000-284043

(51) Int. Cl. B01J 10/00; B32B 5/02; B01J 10/02

(52) U.S. Cl. 422/188; 422/129

(57) ABSTRACT

The present invention provides an apparatus for manufacturing activated carbon fiber, which enables continuous production with high productivity. This apparatus is configured in a U-shape and comprises the first vertical furnace, the second vertical furnace, and the connecting portion to connect both furnaces at the lower parts. This apparatus employs neither the air curtain method nor the water seal method that requires drying process to shut off air from the furnace. In this apparatus, raw materials are introduced from the inlet on the upper part of the first furnace. Then they are subjected to pyrolysis, carbonization, and activation as they pass through the first furnace, connecting portion and the second vertical furnace. Finally they are taken up from the outlet on the upper part of the second furnace to be an active carbon fiber product.

### BACKGROUND OF THE INVENTION

The present invention relates to an apparatus for manufacturing activated carbon products by pyrolysis, carbonization and activation of fibrous materials, such as woven, knitted and non-woven fabrics.

Conventionally, the activated carbon fiber is manufactured by activating a raw material at a high temperature, which is in a sheet form such as woven, knitted and non-woven fabrics, under an environment containing an inert gas and an activating agent. These raw materials are made of phenolic resin fibers, pitch fibers, polyacrylonitrile fibers, and regenerated-cellulose (rayon) fibers, or the like.

In order to obtain an activated carbon fiber of high performance in good yield by means of a manufacturing apparatus for activated carbon fibers, it is important that a flow of the environmental air (oxygen) into the furnace should be shut off and be prevented, so that the temperature and concentration of an activating agent such as steam should be under control as desired.

For example, as described in Japanese Patent laid open publication No. sho 60-145904, a sealed (batch) type activation furnace is well known. This furnace has an advantage that all the activation processes can be carried out in a dry atmosphere, while having a disadvantage that the products cannot be manufactured continuously due to the batch system.

On the other hand, existing activation furnaces enabling continuous production include vertical and horizontal types of furnaces equipped with a mechanism for preventing air from flowing into the furnace. Also, as described in Japanese Patent laid publication No. sho 51-116224, a sequential furnace system in combination of a vertical furnace with a horizontal furnace is known.

In a horizontal furnace, however, there is required an instrument for shutting off an environmental air at the front inlet and rear outlet of the furnace to prevent the air flow into the furnace so controlled as to maintain the oxygen concentration in an activation furnace within a low level. For example, such an apparatus provides a plurality of inert gas curtains. Hence there is raised a problem that expensive equipment and high running costs become inevitable.

On the other hand, in the case of a vertical furnace, due to a large negative pressure generated at the lower opening of the furnace by draft effect, it is difficult to prevent air from flowing in by means of the above air-curtain system used in the horizontal furnace. Therefore, in order to prevent air from flowing in, a water seal method has been employed, wherein a water tank is located at the lower opening of the furnace in order to seal the opening and the resulting activated carbon fibrous products are taken out of water as described, for instance, in Japanese Patent laid open publication No. sho 51-116224.

However, in the water seal method, there is a disadvantage that the activated carbon fibrous product in an absolute dry condition must be once dipped into water and dried again. Further, since a pressure fractures the activated carbon products, drying through draining by means of a mangle cannot be applied. Thus, this method requires a large amount of energy and is time-consuming for drying the activated carbon fiber, which contains much water.

Hence, it is an object of the present invention to solve the above-mentioned problems and to provide an apparatus for manufacturing activated carbon fiber with a novel structure and high production efficiency, which is based on not a closed system but a continuous production system and does employ neither the water seal method requiring a drying process nor the air-curtain method requiring enlargement of associated production facilities such as a means for shutting off the environmental air.

### BRIEF SUMMARY OF THE INVENTION

The present invention relates to an apparatus for manufacturing activated carbon fiber having a U-shaped structure comprising a first vertical furnace, a second vertical furnace, and a connecting portion which connects lower openings of the first and the second vertical furnaces each other, an inert gas introducing device and an activating agent introducing device, wherein a raw material introduced from an upper opening of the first vertical furnace is subjected to pyrolysis, carbonization and activation when passing through the first vertical furnace, the connecting portion and the second vertical furnace, and an activated carbon fiber product is taken up from an upper opening of the second furnace.

In other words, the present invention relates to a U-shaped apparatus for manufacturing activated carbon fiber comprising: a first vertical furnace having an upper opening for introducing a raw material into the apparatus and a lower opening; a second vertical furnace having a upper opening for taking out an activated carbon fiber from the apparatus and a lower opening; and a connecting portion which connects the lower openings of the first and the second vertical furnaces each other, wherein the raw material is thermally decomposed, carbonized and activated while passing through the first vertical furnace, the connecting portion and the second vertical furnace in this order.

It is preferable that each of the above furnaces are equipped with a heater and a temperature controller, and that the temperature of the furnaces can be controlled within a range from 500 to 1200° C.

In addition, the connecting portion preferably has an inert gas feeding port and an inert gas is supplied at a controlled flow rate to the first and second vertical furnaces from the feeding port.

Furthermore, the first and second vertical furnaces preferably have steam feeding ports at their lower portions and steam is supplied at a controlled flow rate as an activating gas from the feeding ports into the first and second vertical furnaces.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a schematic longitudinal sectional view showing the structure of the apparatus for manufacturing activated carbon fiber according to the present invention.

### DETAILED DESCRIPTION OF THE INVENTION

Hereinafter the apparatus for manufacturing activated carbon fiber according to the present invention is described referring to the attached figure. The present invention is however, not necessarily limited to as shown in the figure.

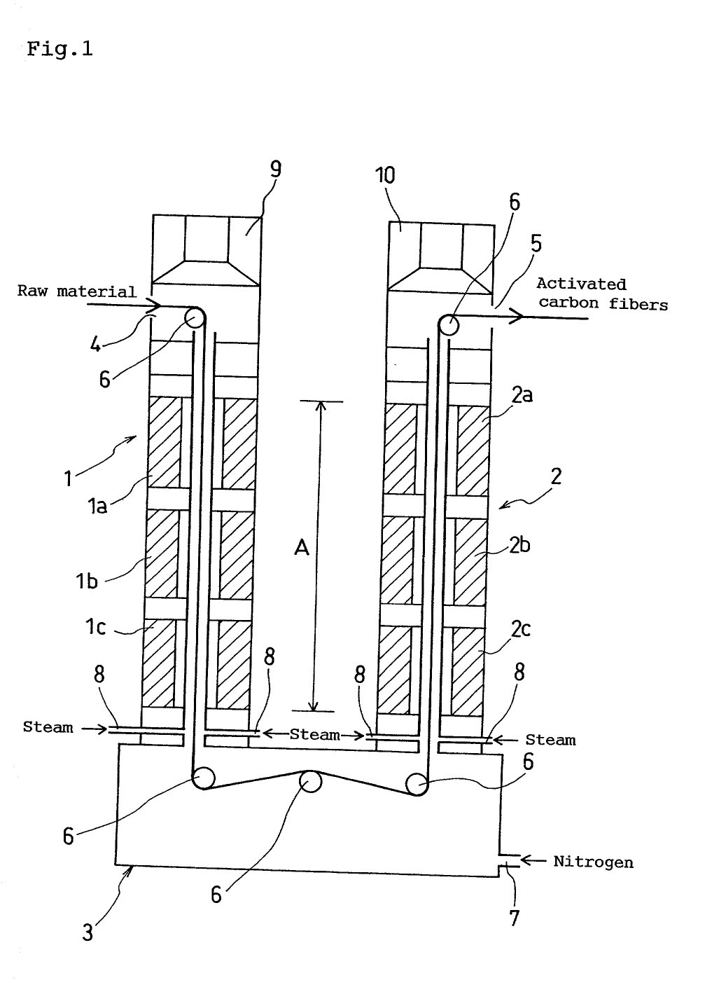

FIG. 1 is a schematic longitudinal sectional view showing the configuration of the apparatus for manufacturing activated carbon fiber of the present invention. As shown in FIG. 1, the apparatus for manufacturing activated carbon fiber according to the present invention comprises a first vertical furnace 1 (hereinafter referred as “the first furnaces”), a second vertical furnace 2 (hereinafter referred as “the second furnace 2”), and a connecting portion 3 which connects the lower parts of the first furnace 1 and the second furnace 2 together, hence forming a U-shape structure. In addition, since the pressure in the connecting portion 3 becomes negative due to draft effect when the furnace temperature is elevated, the apparatus has an air-tight structure so that an environmental air (oxygen) may not flow thereinto.

The fibrous material before being subjected to pyrolysis, carbonization and activation, i.e. the precursor of the activated carbon fiber product, is introduced from the inlet 4 into the upper part of the first furnace as indicated by an arrow in FIG. 1. Then the precursor is subjected to pyrolysis, carbonization and activation during passage through the first furnace, the connecting portion 3 and the second furnace sequentially. Finally the obtained activated carbon fiber product is taken out of the outlet 5 on the upper part of the second furnace.

The precursor used in the present invention means a product made from phenolic resin fibers, pitch fibers, polyacrylonitrile fibers, regenerated cellulose (rayon) fibers, or the like. There is no specific limitation in shapes and the precursor may include a raw material in the form of sheet such as a sheet woven, knitted or non-woven fabrics, textile or cloth.

In order to convey the precursors through the apparatus, the precursor is conveyed sequentially, for instance, by means of the conveyance rollers 6, which are located in place near the upper inlet 4 of the first furnace, the upper outlet 5 of the second furnace, and below the first and second furnaces and at the center of the connecting portion 3.

The temperature conditions in the first and the second furnaces may vary depending on the material of the precursor which will be subjected to pyrolysis, carbonization and activation and on the degree of activation to be attained. It is, however, that a person having an ordinary skill in the art adequately select these processing temperature conditions without difficulty. Usually, in order to perform carbonization and activation, the temperature should be controlled at 500° C. to 1200° C., and more preferably at 700° C. to 1000° C. Further, it is preferable that a plurality of heaters are provided symmetrically along each of the vertical axes within the carbonizing and activating section A of the first and the second furnaces in a manner that the temperatures of the heaters can be controlled individually (1a to 1c and 2a to 2c in FIG. 1).

As the above-mentioned heater, a conventional heater such as a resistance heater using nichrome, tantalum, silicon carbide or the like.

Moreover, it is preferable that the periphery of the first and second furnaces is covered with a thermally insulating material to improve thermal efficiency.

Next, in order to form an inert gas atmosphere in furnaces in the apparatus for manufacturing activated carbon fiber according to the present invention, an inert gas such as nitrogen or argon measured by an inert gas flow-controller (not shown) is introduced from the feeding port 7 located in the lower part of the connecting portion 3 and the inert gas is supplied to the first furnace and the second furnace through the connecting portion 3. This configuration as shown in FIG. 1 creates a negatively pressurized condition in the connecting portion 3 due to an ascending air current caused by the draft effect in the furnaces when the temperatures in the first and second furnace are raised by heating. Then, if an inert gas is introduced into the connecting portion 3 from the feeding port 7 when the inside of the connecting portion 3 is in the negatively pressurized condition, the inert gas is sucked up into the furnaces and exhausted from the inlet 4 of the first furnace 1 and the outlet 5 of the second furnace 2. Thus, even if the inlet 4 and the outlet 5 have become open to an open atmosphere and the furnaces are not in the sealed state, the air does not flow into the furnaces.

Moreover, in order to activate the precursor, a feeding ports 8 for introducing an activating agent may be provided in the lower part of the first and second furnaces and an activating agent such as steam, carbon dioxide or a small amount of oxygen, which have been measured by a flow rate controller, may be introduced into the furnaces. Then, according to the draft effect as mentioned above, the activating agent ascends through the furnaces and the precursor is activated in the pyrolizing, carbonizing, and activating section A.

It is a characteristic feature of the apparatus for manufacturing activated carbon fiber according to the present invention that carbonization and activation reactions proceed sequentially along with pyrolysis, as the precursor running into the inlet 4 of the first furnace passes through the furnaces, and it is ultimately converted to activated carbon product when taken out of the outlet 5 of the second furnace, so that activated carbon products can be manufactured continuously in a dry process.

It is another characteristic feature of the apparatus for manufacturing activated carbon fiber according to the present invention that property of the surface of activated carbon fibers or products to be obtained can be made hydrophilic or hydrophobic as desired by the process. Namely, in order to make the surface hydrophilic, an activating agent may be introduced into both the first and the second furnaces to bake the precursor in an oxidizing atmosphere. Otherwise, in order to make the surface hydrophobic, an activating agent may be introduced into the first furnace to activate the precursor and an inert gas may be introduced into the second furnace instead of an activating agent to bake the precursor in a reducing atmosphere.

It is preferable that a large quantity of gas generated during the process of pyrolysis and activation reactions should be processed with an exhaust gas treatment apparatus. Since the generated gas ascends through inside of the first and second furnaces, it is preferable to provide the exhaust gas treatment instruments 9 and 10 in the upper part of the furnaces. Either the direct combustion type or the catalysis combustion type may be employed for the exhaust gas treatment instruments 9 and 10.

There is no specific limitation for the material of the furnace in the present invention. A material conventionally used for a muffle furnace may be employed, such as stainless steel, iron, heat resistant steel such as nickel chromium alloy, ceramics, heat resistant glass, and carbon.

It is particularly preferable to use a metal from the viewpoint of durability and thermal conductivity of the furnace.

Besides the above, the manufacturing and operating method and the operational conditions of the apparatus for manufacturing activated carbon fiber according to the present invention can be selected adequately by a person having an ordinary skill in the art. For example, as the inert gas introducing device and the activating agent introducing device, conventional ones well known to a person skilled in the art can appropriately be used.

In the following, examples of the present invention are described.

It is noted that the apparatus for manufacturing activated carbon fiber used in the examples has an effective furnace length of 2 m and width of 1.5 m, for both the first and second furnaces. Both furnaces have the first heater zone (1a and 2a), the second heater zone (1b and 2b) and the third heater zone (1c and 2c) in a descending order from the top, and temperatures in these zones can be controlled individually.

### EXAMPLE 1

An activated carbon product was manufactured by the apparatus for manufacturing activated carbon fiber according to the present invention shown in FIG. 1, by using a non-woven fabric made of phenol resin fibers (Kynol(™) available from Nippon Kynol Inc.) which had a weight of 200 g/m² and a width of 1200 mm as a precursor.

The operating conditions of the apparatus for manufacturing activated carbon fiber were set so that the first and second furnaces were symmetric as follows: the furnace temperatures were set stepwise from the upper to the lower part of the first and second furnaces, where the temperatures in the first zone (1a and 2a), the second zone (1b and 2b), and the third zone (1c and 2c) were set at 700° C., 800° C., and 900° C., respectively. Nitrogen was supplied at a flow rate of 200 liter/min from the feeding port 7, as an inert gas. Steam as an activating agent was supplied at a flow rate of 180 liter/min to each furnace from the feeding ports 8 of the lower part of the furnaces. The rate of the precursor or the product passing through the apparatus was 1.0 m/min.

The characteristics of the obtained activated carbon product is shown in Table 1.

### EXAMPLE 2

An activated carbon product was manufactured by the apparatus for manufacturing activated carbon fiber according to the present invention shown in FIG. 1, by using a non-woven fabric made of phenol resin fibers (Kynol(™)) which had a weight of 200 g/m² and a width of 1200 mm as a precursor.

The operating conditions of the apparatus for manufacturing activated carbon fiber were set so that the first and second furnaces were symmetric as follows: the furnace temperatures were set stepwise from the upper to the lower part of the first and second furnaces, where the temperatures in the first zone (1a and 2a), the second zone (1b and 2b), and the third zone (1c and 2c) were set at 800° C., 900° C., and 950° C., respectively. Nitrogen was supplied at a flow rate of 200 liter/min from the feeding port 7, as an inert gas. Steam as an activating agent was supplied at a flow rate of 180 liter/min to each furnace from the feeding ports 8 of the lower part of the furnaces. The rate of the precursor or the product passing through the apparatus was 0.8 m/min.

The characteristics of the obtained activated carbon product is shown in Table 1.

### EXAMPLE 3

An activated carbon product was manufactured by the apparatus for manufacturing activated carbon fiber according to the present invention shown in FIG. 1, by using a non-woven fabric made of phenol resin fibers (Kynol(™) available from Nippon Kynol Inc.) which had a weight of 200 g/m² and a width of 1200 mm as a precursor.

The operating conditions of the apparatus for manufacturing activated carbon fiber were set so that the first and second furnaces were symmetric as follows: the furnace temperatures were set stepwise from the upper to the lower part of the first and second furnaces, where the temperatures in the first zone (1a and 2a), the second zone (1b and 2b), and the third zone (1c and 2c) were set at 850 ° C., 950° C., and 950° C., respectively. Nitrogen was supplied at a flow rate of 200 liter/min from the feeding port 7, as an inert gas. Steam as an activating agent was supplied at a flow rate of 180 liter/min to each furnace from the feeding ports 8 of the lower part of the furnaces. The rate of the precursor or the product passing through the apparatus was 0.4 m/min.

The characteristics of the obtained activated carbon product is shown in Table 1.

### EXAMPLE 4

An activated carbon product was manufactured by the apparatus for manufacturing activated carbon fiber according to the present invention shown in FIG. 1, by using a non-woven fabric made of phenol resin fibers (Kynol(™) available from Nippon Kynol Inc.) which had a weight of 200 g/m² and a width of 1200 mm as a precursor.

The operating conditions of the apparatus for manufacturing activated carbon fiber were set so that the first and second furnaces were symmetric as follows: the furnace temperatures were set stepwise from the upper to the lower part of the first and second furnaces, where the temperatures in the first zone (1a and 2a), the second zone (1b and 2b), and the third zone (1c and 2c) were set at 850° C., 950° C., and 950° C., respectively. Nitrogen was supplied at a flow rate of 200 liter/min from the feeding port 7, as an inert gas. In addition, steam was supplied at a flow rate of 200 liter/min from the feeding port 8 of the lower part of the first furnace as an activating agent. Further, nitrogen, instead of steam, was supplied at a flow rate of 200 liter/min from the feeding port 8 of the lower part of the second furnace. The rate of the precursor or the product passing through the apparatus was 0.4 m/min.

The obtained activated carbon floated on the surface of water, while those of Examples 1 to 3 sank under water. Moreover, the ESCA measurement revealed that the oxygen concentration in the activated carbon product of Example 4 was remarkably less than those of Examples 1 to 3. Thus the activated carbon product obtained in Example 4 was certainly of the hydrophobic nature.

TABLE 1

| | | | | | | Physical properties | | | |
|---|---|---|---|---|---|---|---|---|---|
| | Manufacturing conditions | | | | | | BET | Average | Yield |
| | | Furnace | | | | Iodine | specific | pore | in |
| | Steam | temperature | | | Rate | Adsorption | surface | size | weight |
| Ex. | (1/min) | 1 | 2 | 3 | (m/min) | (mg/g) | area (m²) | (Å) | (%) |
| 1 | 180 | 700 | 800 | 900 | 1.0 | 1200 | 1300 | 15.5 | 46 |
| 2 | 180 | 800 | 900 | 950 | 0.8 | 1350 | 1500 | 16.0 | 35 |
| 3 | 200 | 850 | 950 | 950 | 0.4 | 1750 | 2000 | 16.4 | 25 |

Iodine adsorption was measured based on JIS K-1477. The BET specific surface area and the average pore size were measured using ASAP 2010 manufactured by Micromeritex Co.

Hence the present invention provides an industrially significant apparatus for manufacturing activated carbon fiber with low equipment cost and running cost with an excellent productivity, without using a large-scale attachment facility such as those utilizing an air curtain to shut off air flowing into the furnace.

Moreover, according to the apparatus of the present invention, an activated carbon fiber with surfaces either hydrophilic or hydrophobic nature is obtained as desired.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. An apparatus for manufacturing activated carbon fiber with a U-shaped structure comprising a first vertical furnace, a second vertical furnace, a connecting portion which connects lower openings of said first and second vertical furnaces, an inert gas introducing device and an activating agent introducing device,
wherein a raw material introduced from an upper opening of said first vertical furnace is subjected to pyrolysis, carbonization and activation when sequentially passing through said first vertical furnace, said connecting portion and said second vertical furnace, and an activated carbon fiber product is taken up from an upper opening of said second furnace.

2. The apparatus for manufacturing activated carbon fiber in accordance with claim 1, wherein the temperature in said vertical furnaces is controlled in a range of 500° C. to 1200° C.

3. The apparatus for manufacturing activated carbon fiber in accordance with claim 1, wherein an inert gas is supplied at a controlled flow rate from a feeding port provided in said connecting portion to said first and second vertical furnaces.

4. The apparatus for manufacturing activated carbon fiber in accordance with claim 1, wherein an activating agent is supplied at a controlled flow rate from a feeding portion provided in a lower part of said first and second vertical furnaces.

5. The apparatus for manufacturing activated carbon fiber in accordance with claim 1, wherein nitrogen is used as said inert gas.

6. An apparatus for manufacturing activated carbon fiber according to claim 1, wherein steam is used as activating agent.
